(19) United States
(12) Patent Application Publication
(10) Pub. No.: US 2015/0024138 A1
(43) Pub. Date: Jan. 22, 2015

(54) METHOD FOR FORMING A SPRAYABLE NONISOCYANATE POLYMER FOAM COMPOSITION

(71) Applicants: POLYMATE, LTD., (US); NANOTECH INDUSTRIES, INC., (US)

(72) Inventors: Oleg Figovsky, Haifa (IL); Raisa Potashnikov, Migdal Ha'Emeq (IL); Alexander Leykin, Haifa (IL); Leonid Shapovalov, Nesher (IL); Sergey Sivokon, Haifa (IL)

(73) Assignees: NANOTECH INDUSTRIES, INC., Daly City, CA (US); POLYMATE, LTD., Migdal Ha'Emeq (IL)

(21) Appl. No.: 13/770,319

(22) Filed: Feb. 19, 2013

(51) Int. Cl. C08J 9/00

(52) U.S. Cl. CPC C08J 9/0028
USPC 427/427.4

(57) ABSTRACT

Provided is a method for the spray application of a nonisocyanate polymer foam composition. The method comprises the steps of supplying dosed quantities of the components of the nonisocyanate polymer composition to the mixing chamber where the components react with each other and form a foamable nonisocyanate polymer composition, transferring the foamable nonisocyanate polymer composition to the intermediate chamber of a foam application apparatus and continuously moving the foamable nonisocyanate polymer composition through the intermediate chamber while constantly controlling the parameters of the foamable nonisocyanate polymer composition in the intermediate chamber for providing conditions most optimal for the spray application onto the substrate.

### BACKGROUND OF THE INVENTION

1. Technical Field

The described techniques relate to a process for forming a sprayable nonisocyanate polymer foam. More specifically, the described techniques relate to a method for forming a nonisocyanate foam that has low reactivity and is suitable for spray application.

2. Description of the Related Art

The vast majority of methods for application of sprayable polymer foams onto various substrates comprise air or airless spraying of conventional polyurethanes. The main advantage of these methods is rapid formation of a polymer structure and obtaining a nonflowing foam on vertical surfaces. However, in recent years, an urgent need has occurred for replacement of polyurethane compositions intended for use in open areas and especially in closed premises because isocyanates that are used as raw materials for polyurethanes are highly toxic and produce a detrimental effect on human health and the environment.

Spray foaming is a process in which two or more reactive components are mixed, e.g., in a mixing head of a foam sprayer, where they begin to react. The resulting reaction mixture is then sprayed onto the surface of a substrate where the foam mixture is cured, thus forming a cured foam layer on the surface.

A typical conventional head suitable for spray foaming is described in U.S. Pat. No. 4,332,335, issued to Fiorentini on Jun. 1, 1982. The head comprises a mixing chamber that communicates with a discharge orifice and first and second ducts, which dispense the reactive components into the mixing chamber. Means are provided for regulating the flow of the reactants to the reaction chamber. Use of such a head for spraying on vertical surfaces suggests that the foam-forming composition should have low viscosity at the time of spraying and a fast curing speed to prevent gravity-induced sagging or running of the foam. Therefore, such spraying methods and equipment have been used primarily for foam-forming compositions consisting of polyurethane and polyurea resins, which have the combination of low viscosity and fast curing rate.

However, nonisocyanate resin foams require some other approach since they exhibit longer durations of gelation and solidification, which can lead to flow on vertical surfaces and a collapse of the foam.

Generally, nonisocyanate resin foams, particularly on the basis of epoxy resins, are well known in the art. Epoxy/amine foam materials exhibit improved mechanical properties (good balance of high compressive strength, compressive modulus, glass transition temperature, and cured ductility), as well as enhanced shear-thinning characteristics. As a result, numerous industries including maintenance, marine, construction, architectural, aircraft, and product finishing have adopted broad usage of epoxy foam materials.

The most common epoxy materials used in the industry today are multipart epoxy materials. In general, epoxy compositions of the aforementioned type include a base resin matrix and at least a catalyst or hardener, although other components such as technological additives (blowing agents, surface-active substances, etc.), anticorrosive additives, light stabilizers, pigments, and aggregate components may also be added.

While the two parts that are needed to form foam as a result of a reaction (i.e., part (A), which contains epoxy and/or an acrylate/methacrylate, and/or cyclic carbonate groups; and part (B), which contains amino groups) are kept separate, they remain in a liquid form. After these two parts are mixed together, they begin a curing process at ambient conditions. The curing reaction is exothermic and is accompanied by generation of heat.

U.S. Pat. No. 7,473,715 issued on Jan. 6, 2009 to Czaplicki, et al, and U.S. Pat. No. 6,787,579 issued on Sep. 7, 2004 to Czaplicki, et al, disclose a two-component (epoxy and amine) structural foam-in-place material and the methods of production thereof, comprising the combining of an epoxy-based component with an amine-based component. The epoxy component is cross-linked through a polymerization reaction catalyzed by the amine formulation. In this regard, a reactive mixture or exothermic reaction is created between the epoxy component and the amine component when combined. The heat generated by the exothermic reaction softens the thermoplastic shell of the blowing agent formulated within the epoxy component, thereby enabling the solvent core within the thermoplastic shell of the blowing agent to expand from the heat generated by the exothermic or reactive mixture. The reactive mixture may also include an aliphatic acrylic or methacrylic ester.

U.S. Pat. No. 6,110,982 issued to Russick, et al, on Aug. 29, 2000 discloses a pourable epoxy foam comprising a plurality of resins, a plurality of curing agents, at least one blowing agent, at least one surfactant and, optionally, at least one filler, and the process for making the foam. Preferred is epoxy foam comprising two resins of different reactivities, two curing agents, a blowing agent, a surfactant, and a filler. According to the invention, epoxy foam is prepared with tailorable reactivity, an exotherm, and pore size by means of the process of admixing a plurality of resins with a plurality of curing agents, a surfactant, and a blowing agent, whereby a foamable mixture is formed and is heated at a temperature greater than the boiling temperature of the blowing agent, whereby said mixture is foamed and cured.

U.S. Pat. No. 7,850,049 issued to Ciavarella, et al, on Dec. 14, 2010 discloses a foam pump with improved piston structure. The foam pump includes a piston housing and a piston assembly received in the piston housing thereby defining a collapsible liquid chamber and a collapsible air chamber. The piston assembly includes a premix chamber separated from both the collapsible liquid chamber and the collapsible air chamber by a premix chamber wall and fluidly communicates with both the collapsible liquid chamber and the collapsible air chamber through a mix aperture in the premix chamber wall. A biasing member urges the piston assembly to a non-actuated position. The foam pump is actuated by urging the piston assembly against the biasing member to an actuated position in which the collapsible air chamber and the collapsible liquid chamber are reduced in volume such that air and foamable liquid are expelled from their respective collapsible air chamber and collapsible liquid chamber through the mix aperture. The simultaneous movement of the air and foamable liquid through the mix aperture causes a turbulent mixing thereof.

U.S. Pat. No. 6,492,432 (issued on Dec. 10, 2002), U.S. Pat. No. 6,610,754 (issued on Aug. 26, 2003) and U.S. Pat. No. 6,727,293 (issued on Apr. 27, 2004), all to Rader, disclose a sprayable novolac-epoxy resin foam having a cross-linked polymeric matrix formed by spraying a foamable composition having a viscosity of about 50 to about 1000 centipoise at 25° C. The composition comprises at least one liquid novolac resin having a viscosity of about 100 to about 3,000 centipoise at 25° C., at least one liquid epoxy resin having a viscosity of about 100 to about 10,000 centipoise at 25° C., and at least one reactive blowing agent that generates a blowing gas by the reaction that occurs during curing of the novolac resin and epoxy resin and provides heat of reaction to increase cure speed, wherein the composition is formulated such that when the novolac resin and epoxy resin are combined during foaming, no external heat beyond ambient temperature is required to initiate formation of the foam and, once foaming is initiated, the heat from the reactive blowing agent increases the cure speed.

However, the proposal is not feasible due to mismatch of the stated parameters of the process with disclosed raw materials.

US Patent Application Publication No. 20120183694 (published on Jul. 19, 2012; inventor: Olang) discloses hybrid spray foams that use a urethane reactant, a crosslinker, and an (optional) epoxy and/or acrylic resin, along with a blowing agent and rheology modifier to produce a quick-setting foam that remains in place until the foam forms and cures. The urethane reactant may be formed as an adduct with or without the use of isocyanate chemistry. In some embodiments, the polyurethane oligomer is made by reacting cyclocarbonates and di- or polyamines, while in other embodiments the polyurethane backbone employs the use of commercially available capped or blocked urethane oligomers made according to any method. The oligomers contain reactive groups, typically at the oligomer ends, that crosslink with crosslinkers or with acrylic or epoxy resins to form hybrid polyurethane foams. Foams may also contain a plasticizer, and/or a surfactant, as well as other optional additives. The methods of making such foams are also provided. However, use of rheology modifiers in practice increases the viscosity of the compositions and imparts to them a thixotropic property, which significantly limits the use of this method for spray foams.

Earlier we described some nonisocyanate compositions related to hybrid systems on the basis of epoxy, hydroxyurethane, acrylic, cyclic carbonate, and amine raw materials in different combinations. U.S. Pat. No. 6,960,619 issued to Figovsky, et al, on Nov. 1, 2005 discloses foamable, photopolymerizable liquid acrylic-based compositions for sealing applications, which include products of reaction of nonisocyanate urethane diols with methacrylic or acrylic anhydride. U.S. Pat. No. 7,232,877 issued to Figovsky, et al, on Jun. 19, 2007 describes hybrid nonisocyanate foams and coatings on the base of epoxies, acrylic epoxies, acrylic cyclocarbonates, acrylic hydroxyurethane oligomers, and bifunctional amines.

However all these compositions are used “in-place” (in situ) and are unsuitable for spray applications.

Thus, the prior-art methods do not provide foam compositions with the balance of properties needed for application of foam-forming mixtures onto vertical substrates.

As known by those skilled in the art, the foam-formation process, in which a blowing agent forms cells in a synthetic resin during curing, depends on a number of factors. Most importantly are the rate of cure and the blowing gas generation rate, which must be properly matched. The aforementioned components that define a foamable nonisocyanate polymer composition form a relatively slow reacting system. At ambient temperature, the pot life of such compositions is not less than 5 min. On the other hand, premature application of the forming foam product onto a substrate must be avoided because as soon as the foam composition is applied, the foam rapidly expands, and this may cause the expanding foam to collapse as a result of inadequate strength of the walls surrounding the individual gas cells. In other words, synchronization of curing and foaming processes is a very important factor that is not provided by conventional methods of producing sprayable nonisocyanate polymer foams.

### SUMMARY OF THE INVENTION

The inventive methodology is directed to methods and systems that substantially obviate one or more of the above and other problems associated with conventional techniques for spray foaming.

Various aspects of the inventive techniques described herein relate to a method for spray application of a sprayable nonisocyanate polymer foam composition that comprises at least an amino-reactive component, an amino-containing component, a blowing agent, and additives. The components are separated into two parts, i.e., part (A) on the basis of an amino-reactive compound, and part (B) on the basis of an amino-containing compound. Parts (A) and (B) are prepared from the aforementioned compounds in dosed quantities and are prepackaged. For spray application, parts (A) and (B) are loaded under pressure into a foam-spraying apparatus that is provided with a mixing chamber, component inputs to the mixing chamber, an intermediate chamber of a predetermined volume connected to the mixing chamber, a control unit for controlling conditions of the foam of a predetermined volume in the intermediate chamber, and a foam composition discharge nozzle. Parts (A) and (B) are loaded in dosed quantities into the mixing chamber of the foam-spraying apparatus, where they are mixed. This starts an exothermic chemical reaction between the amino-reactive and amino-containing components that is accompanied by heat generation. Then the mixture is transferred to the intermediate chamber in which it is held for a predetermined time, experimentally determined for the specific foamable composition in order to provide conditions most optimal for the application of the foamable composition onto the substrate. In the intermediate chamber, the chemical process of polymer formation occurs under quasiadiabatic conditions, i.e., without heat exchange with the environment, and with continuous movement of the reaction mass. Under such conditions, the temperature is well correlated with the degree of chemical transformation and, thus, with the strength of the walls of the foam cells and their ability to retain the blowing agent. While the foamable material is heated, the boiling point of the blowing agent is achieved, and the foamable composition is prepared for foaming after spraying onto the substrate. If the conditions of the composite mixture in the intermediate chamber are correctly adjusted, the closed-cell foam stays in place and does not sag when applied on a vertical substrate. The temperature of the mixed composition in the intermediate chamber is a parameter most suitable for controlling the formation of a foamable nonisocyanate composition that is most optimal for spray application.

In one or more embodiments, the amino-reactive component is the main component of part (A) and is selected from the group consisting of an epoxy functional compound, an acrylic functional compound, a methacrylic functional compound, a cyclic carbonate functional compound, or mixtures thereof. Furthermore, at least one compound of the amino-reactive component should contain at least two epoxy functional groups.

The amino-containing component is the main component of part (B) and is selected from the group consisting of a primary amine functional compound, a secondary amine functional compound, a tertiary amine functional compound, a hydroxycarbamate functional compound, or a mixture thereof. Furthermore, at least one compound of the amino-containing component should contain at least one primary amine functional group.

Parts (A) and (B) should be mixed in a ratio ranging from (2:1) to (6:1). The residence time in the intermediate chamber depends on the specific parameters of the mixture but in general can range from 0.5 to 15 minutes.

In one or more embodiments, the described method makes it possible to balance the composition with the properties of the final foam coating and provides “drying time” on the working surface of no more than 60 seconds for the formation of a sprayed foam coating in a wide range of properties from rigid to highly elastic.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a schematic side view of an apparatus for application of foam coatings in accordance with the method of the invention.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

Various embodiments of the invention relate to a system and method for forming a sprayable nonisocyanate polymer foam composition that comprises at least an amino-reactive component, an amino-containing component, a blowing agent, and appropriate additives. The components are separated into two parts, i.e., part (A) on the basis of amino-reactive component and part (B) on the basis of amino-containing component. Parts (A) and (B) are prepared from the aforementioned components in dosed quantities and are prepackaged. Parts (A) and (B) are stored separately from each other in a liquid form. When the parts are loaded under pressure into a foam-spraying apparatus and mixed, they form a foamable composition, which is transferred into an intermediate chamber of a foam-spray apparatus where the composition is constantly moving through the intermediate chamber at a predetermined flow rate to provide the predetermined residence time needed to obtain optimal conditions for spraying the foam onto the substrate.

Prior to a detailed explanation of the method of the invention, it is appropriate to briefly describe an exemplary embodiment of an apparatus suitable for carrying out the method of the invention.

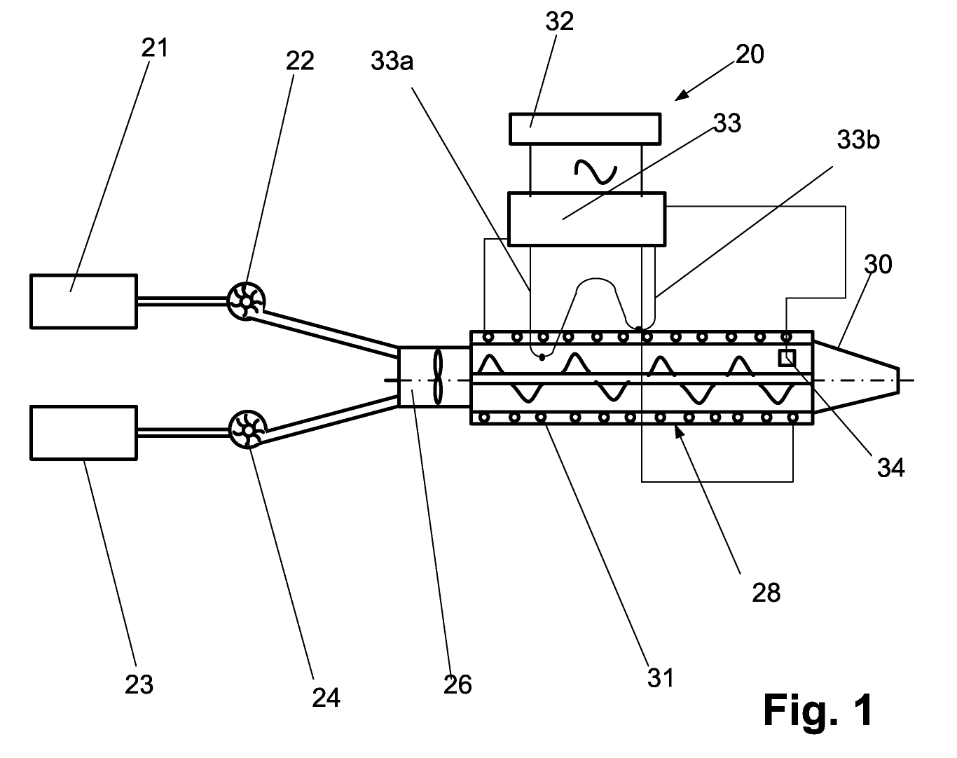

FIG. 1 is a schematic side view of an example of an apparatus for application of foam in accordance with the method of the invention.

In various embodiments, the apparatus, which as a whole is designated by reference numeral 20, may comprise an apparatus for preparing a foamable composition and for applying the composition under pressure onto horizontal, inclined, or vertical substrates, as well for pouring the composition into various slots, recesses, etc. The apparatus suitable for the method of the invention differs from a conventional apparatus of this type by provision of an intermediate chamber, the function of which is explained below. More specifically, the apparatus 20 comprises a first component container 21, a second component container 23, a first component-loading device 22, and a second component-loading device 24 for dosed input of the respective components into the mixer 26.

Although in the description of the present invention the first and second materials that are loaded into the apparatus are called “components”, in fact each component is not a single compound and may contain other constituents. For example, as described below, the first component that contains an amino-reactive compound as an indispensible constituent may also contain a blowing agent, a surface-active substance, or the like.

In various embodiments, the components are loaded into the mixer 26 where part (A) and (B) components are uniformly mixed and begin to react with each other. From the mixer, the reactive mixture is transferred to an intermediate chamber 28, through which the reactive mixture passes to a discharge nozzle 30 during the predetermined residence time needed for completing a reaction to the formation of the foamable composition optimal for application onto the substrate. It is important to note that in order to provide continuity of the foam application process, the component-loading devices and mechanisms of mixing and transfer of components and their mixtures should be adjusted to provide continuous movement of the material from the loading devices to the discharge nozzle 30. At the same time, a predetermined residence time of the mixture should be provided in the intermediate chamber 28 to obtain optimal conditions for spraying the foam onto the substrate.

In various embodiments, the apparatus 20 may also incorporate a supply of compressed air that may be needed, e.g., for purging the mixer 26, the intermediate chamber 28, and the discharge nozzle 30 at the end of the foam-forming process. Other devices may comprise a solvent supply unit (not shown) for supplying the solvent needed to clean the interior of the apparatus on completion of the foam application operation. The loading devices 22 and 24 for loading part (A) and part (B) components may comprise, e.g., dosing pumps.

In one or more embodiments, in the mixer 26, the exothermic chemical reaction between the amino-reactive and amino-containing components starts and is accompanied by generation of heat. In the intermediate chamber 28, the chemical process of polymer formation occurs under quasiadiabatic conditions, i.e., without heat exchange with the environment, while the reaction mass continuously moves. Under the above-described conditions, the temperature in the intermediate chamber 28 is well correlated with the degree of chemical transformation of the reaction mass and thus with the strength of the walls of the foam cells and their ability to retain the blowing agent. Therefore, the temperature of the mixed composition in the intermediate chamber may serve as a parameter most suitable for optimally controlling the formation of the foamable nonisocyanate composition for spray application.

In one or more embodiments, while the foamable material is heated, the boiling point of the blowing agent is achieved, and the composition is prepared for foaming after spraying onto the substrate. If the conditions of the composite mixture in the intermediate chamber are correctly adjusted, the closed-cell foam stays in place and does not sag when applied onto a vertical substrate.

In one or more embodiments, to ensure the quasiadiabatic conditions, the intermediate chamber 28 may include thermal insulation and may be provided with a heater 31, e.g., in the form of a resistance heater that is energized from a power source 32 that is connected to the heater 31 via a temperature control unit 33. The temperature control unit 33 may include a differential thermocouple and a temperature sensor 34 for determining the temperature of the foamable mixture at the exit from the intermediate chamber 28. One junction 33a of the thermocouple is located inside the intermediate chamber, and the other junction 33b is located on the insulated outer wall of the intermediate chamber 28. On and off adjustments of the heater 31 provide zero temperature difference between the two thermocouple junctions 33a and 33b. Such a device may be, e.g., of the type used by Tonoyan A. O., Leykin A. D., Davtyan S. P., Rozenberg B. A., and Yenikolopyan, N. S. in their studies of the kinetics of adiabatic polymerization (see “Kinetics of the adiabatic polymerization of methyl methacrylate” in Polymer Science U.S.S.R., 1973, 15, 8, pp. 2080-2085).

More specifically, in one or more embodiments, the control unit 33 determines the temperature of the foamable mixture inside the intermediate chamber 28 and the difference (ΔT) between the temperature inside the intermediate chamber and the temperature in the insulated outer wall. The control unit 33 controls operation of the heater 31, maintaining the intermediate chamber 26 under quasiadiabatic conditions, i.e., providing ΔT→0.

The details of the first material loading device 22, the second material loading device 24, the mixer 26, the intermediate chamber 28, etc., are omitted because they are beyond the scope of the present invention and may be of any appropriate type. For example, the mixer 26 may operate on the principle of mechanical mixing, jet mixing, or turbulent mixing in a spiral unit, etc. The reaction mass can be transported through the intermediate chamber 28, e.g., by a screw-type feeder, or the like.

As mentioned above, in order to provide continuity of the process during foam application onto the substrate, the foamable mixture does not stay immobile in the intermediate chamber 28 but rather continuously moves through it at a predetermined volume flow rate (velocity). This volume velocity (S) is one of important parameters of the process.

Therefore, in one or more embodiments, in order to establish optimal parameters of the process, the residence time in the intermediate chamber must be predetermined under static conditions for each specific composition and process. The predetermined residence time of the foamable nonisocyanate polymer composition in the intermediate chamber is defined as cream time (according to the American Society of Testing and Materials (ASTM) D7487), i.e., the interval between mixing together the composition components and the first definite appearance of foam.

The necessary volume velocity (or flow rate), S, can be calculated by formula (I):

S=V/t (1),

where V is the volume of the intermediate chamber 28, and t is the residence time of the foamable reacting mixture in the intermediate chamber 28.

In one or more embodiments, the flow rate of the components of the foamable nonisocyanate polymer composition during their loading into the mixing chamber by means of the dosed inputs can be determined based on the flow rate of the mixture and the appropriate composition e.g., in the following manner:
taking into account a specific given foamable composition,
taking into account a given intermediate chamber volume,
mixing the selected foamable composition and checking it under static quasiadiabatic conditions in a test chamber of a specified volume,
determining the residence time; and
calculating the flow rate of the composition by formula (I).

In one or more embodiments, the amino-reactive component is selected from the group consisting of an epoxy functional compound, an acrylic functional compound, a methacrylic functional compound, a cyclic carbonate functional compound, and mixtures thereof. Furthermore, at least one compound of the amino-reactive component should contain at least two epoxy functional groups. The amino-containing component is selected from the group consisting of a primary amine functional compound, a secondary amine functional compound, a tertiary amine functional compound, a hydroxycarbamate functional compound, and [or?] mixtures thereof. Furthermore, at least one compound of the amino-containing component should contain at least one primary amine functional group.

More specifically, the following compounds exemplify the constituents of the amino-reactive component.

### Epoxy

In one or more embodiments, the part (A) component typically includes compounds with two functional epoxy groups, which may comprise epoxy resin groups of one type or epoxy resin groups of several different types. The epoxy constituent may be selected from the following compounds: a diglycidyl ether of bisphenol-A or bisphenol-F, hydrogenated diglycidyl ether of bisphenol-A, polyglycidyl ether of novolac resin with oxyrane functionality from 2.2 to 4, di- or polyglycidyl ether of an aliphatic polyol, di- or polyglycidyl ether of cycloaliphatic polyol, and an additional monofunctional reactive diluent selected from the group consisting of aliphatic glycidyl ether, aliphatic glycidyl ester, and aromatic glycidyl ether, and/or combinations thereof. Examples of preferred epoxy resins, which may be used separately or in combination, include the bisphenol-A epoxy resin, D.E.R. 331™ (Dow Chemical, MI, USA); the polyglycol diglycidyl ether, ERISYS™ GE-23 (CVC Specialty Chemicals), and the hydrogenated bisphenol-A epoxy resin, Epalloy™ 5000 (CVC Specialty Chemicals). Other epoxy resins that may be suitable in the present invention in a particular application include D.E.N. 431, D.E.R. 354, and D.E.R. 324 from Dow Chemical.

### Acrylates and Methacrylates

Examples of preferred acrylates and methacrylates may include the following: aliphatic acrylate modifier for epoxy/amine systems—a mixture of pentaerythritol tetracrylate, pentaerythritol triacrylate, and 1,6-hexanediol diacrylate that is sold under the tradename M-Cure® 400 by Sartomer Co., Inc., PA, USA. Other modifiers from Sartomer Co. are M-Cure® 200 (a mixture of aromatic acrylic esters), M-Cure® 201 (a mixture of 1,4-butanediol diacrylate and trimethylolpropane triacrylate), M-Cure® 300 (a mixture of propoxylated glyceryl triacrylate and trimethylolpropane triacrylate); and QualiCure® GU 1800W, an acrylated epoxidized soybean oil (AESO) by Qualipoly Chemical Corp., Taiwan.

### Amine-Containing Compounds

In one or more embodiments, the amine-contained component is exemplified by compounds selected from the following: primary amine functional compounds, secondary amine functional compounds, tertiary amine functional compounds, hydroxycarbamate functional compounds, and mixtures thereof. At least one compound of an amine-contained component should contain at least one primary amine functional group.

### Primary Amines

In one or more embodiments, the primary amine is exemplified by 2,2,4-(2,4,4)-trimethyl-1,6-hexanediamine, 1,3-diaminopentane, 1,6-hexanediamine, neopentanediamine, 2-methyl-1,5-pentanediamine, meta-xylylene diamine, isophorone diamine, 1,3-bis(aminomethyl)cyclohexane, 1,2(1,4)-cyclohexane diamine, 4,4′-diaminodicyclohexyl-methane, 3,3′-dimethyl-4,4′-diamino-dicyclohexylmethane, octahydro-4,7-methano-1H-indenedimethyl amine, polyoxyalkylene diamine, and polyoxyalkylene triamine.

Amine Compounds with Primary and Secondary Amino Groups

These compounds are exemplified by polyalkylenamines such as diethylenetriamine, triethylenetetramine, tetraethylenepentamine, pentaethylenehexamine, dipropylenetriamine, bis(hexamethylene)triamine, N-aminoethylpiperazine, and 1,4-bis-(3′-aminopropyl)-piperazine.

The tertiary amine functional compounds, including compounds with tertiary and also primary (and secondary) amino groups are exemplified by 2,4,6-tris(dimethylaminomethyl) phenol, 1,3-bis-[3-(dimethylaminopropyl)urea, dimethylbenzylamine, pentamethyldiethylene triamine, tetramethylbis(aminoethyl)ether, triethanolamine, N,N-bis-(3-aminopropyl) methylamine, N-(6-aminohexyl)-N-methyl-1,6-hexanediamine, and dimethylaminopropylamino-propylamine.

Particularly preferred amines are the following: aminoethyl piperazine which is mixed with nonylphenol and is sold under the tradename Ancamine™ 1786, which is commercially available from Air Products, Inc., PA, USA; N,N-bis-(3-aminopropyl)-ethylenediamine which is mixed with salicylic acid and is sold under the trade name Ancamine™ 2678, which is also commercially available from Air Products; Jeffamine® EDR-148 (triethyleneglycol diamine) and Jeffamine® T403 (polyoxypropylene triamine), which is commercially available from Huntsman Corp., TX, USA; and MXDA (meta-xylenediamine) from Mitsubishi Gas Chemical America, Inc., NY, USA, and Ancamine® K54 (2,4,6-tris(dimethylaminomethyl) phenol) from Air Products.

In one or more embodiments, the hydroxycarbamate functional compounds may include carbamic acid, N,N′-[2,2,4 (2,4,4)-trymethyl-1,6-hexanediyl]bis-, ester with 1,2-propanediol (1:2) which is sold under the trademark HUM™-01, [not found anywhere—kjay] and N-[3-[(carboxyamino)methyl)]-3,5,5-trimethylcyclohexyl]-, ester with 1,2-propanediol (1:2) which is sold under the trademark HUM™-14. Both are commercially available from Hybrid Coating Technologies, CA, USA. Other hydroxycarbamate functional compounds can be prepared from amines with primary amine groups and cyclic carbonates, described above and according to the method disclosed in the U.S. Pat. No. 7,989,553 incorporated herein by reference.

Other hydroxycarbamate functional compounds (HFC) include adducts of polycyclic carbonates and primary amine group-containing compounds.

Examples of preferred polycyclic carbonates are the following: tricyclocarbonate of trimethylol propane (on the basis of Polypox® R20, UPPC—Dow Chemical, Germany) in accordance with U.S. Pat. No. 7,232,877, examples 11 (Stage II) and 6; polyoxypropylated trimethylol propane with cyclocarbonate terminal groups (Cycloat® A); and CSBO—carbonized soybean oil (Urethane Soy Systems, USA).

Preferred blowing agents are selected from the group consisting of saturated and unsaturated hydrofluorocarbons (HFCs), unsaturated hydrochlorofluorocarbons (HCFCs), alkylhydrogensiloxane, and also hydrocarbons. Some of the blowing agents are summarized in Table 1.

In one or more embodiments, additives are selected from the group consisting of surface-active substances of different natures and mixtures thereof. Other additional additives comprise antisagging, antimold agents, etc., pigments, and mixtures thereof.

### Surface-Active Substances

Examples of surface-active substances are Dabco® DC193, Dabco® DC197, Dabco® DC5582, and Dabco® LK-443, all of which are available from Air Products, Inc., PA, USA.

As a rule, blowing agents and additives are included in compositions of part (A) and/or part (B) components.

As mentioned above, the components are separated into two parts, i.e., the part (A) component on the basis of an amino-reactive component, and the part (B) component on the basis of an amino-containing component. Part (A) and (B) components are prepared from the aforementioned components in dosed quantities and are prepackaged.

Part (A) and (B) components should be mixed at a volume ratio ranging from (2:1) to (6:1).

TABLE 1

| | | Boiling |
|---|---|---|
| | | point, |
| Code and Name | Commercial Name | T_{b}, ° C. |
| HFC-227ea | FM-200, | −16.5 |
| 1,1,1,2,3,3,3- | DuPont Fluoroproducts | |
| Heptafluoropropane | (DE, USA) | |
| HFC-236fa | SUVA ® 236fa, | −1.4 |
| 1,1,1,3,3,3-hexafluoropropane | DuPont Fluoroproducts | |
| | (DE, USA) | |
| HFC-245fa | Enovate ® 3000, | 15.3 |
| 1,1,1,3,3-pentafluoropropane | Honeywell | |
| | (NY, USA) | |
| HFC-365mfc | Forane ® 365mfc, | 40.2 |
| 1,1,1,3,3-Pentafluorobutane | Arkema Inc. (PA, USA); | |
| | Solkane ® 365mfc, | |
| | Solvay Fluorides, Inc. | |
| | (TX, USA) | |
| HFC-43-10mee | Vertrel ® XF, | 55 |
| 1,1,1,2,2,3,4,5,5,5- | DuPont Fluoroproducts | |
| Decafluoropentane | (DE, USA) | |
| [HFC-336] | FEA 1100, | 33 |
| 1,1,1,4,4,4-hexafluoro-2-butene | DuPont Fluoroproducts | |
| | (DE, USA) | |
| [HCFC-233] | Solstice ® LBA, | 19 |
| trans-3,3,3-trifluoro-1- | Honeywell | |
| chloropropene | (NY, USA) | |
| Polymethylhydrogensiloxane | Dow Corning 1107 ® | — |
| | Fluid, Dow Corning Corp. | |
| | (MC, USA) | |
| n-Pentane | | 36 |
| iso-Pentane | | 28 |
| Cyclopentane | | 49 |

The residence time t in the intermediate chamber depends on the specific parameters of the mixture but in general can range from 0.5 to 15 minutes.

In one or more embodiments, the described method makes it possible to balance the composition with properties of the final foam and provides a “tack-free” time (according to ASTM D7487) of no more than 60 seconds for the formation of foam in a wide range of properties from rigid to flexible.

### EXAMPLES

The following examples are provided to further illustrate the scope of the present invention; however, they should not be construed as limiting the scope of application of the invention.

In these examples, the foamable composition components were mixed by turbulent mixing in a spiral mixer. In all experiments a thermal-insulated intermediate chamber having a volume of 500 ml was used. The ambient temperature ranged from 25 to 27° C. No gravity-induced sagging or running of the foam was observed in Examples 1 to 5, which corresponded to the method of the invention. Curing reactions were amine-reactive nonisocyanate compounds with amine-containing compounds. Foam formation was achieved by foaming a blowing agent during exothermic curing reactions. The composition was applied onto a vertical substrate (concrete) and the application process was evaluated by dry-touch time, which is the time interval from spraying to the condition in which the coat has dried to the extent that foreign substances do not stick to the coated surfaces.

### Example 1

| Components | | Content (vol. %) |
|---|---|---|
| Part A: | Epoxy resin DER-331 | 81.8 |
| | DC-1107 Fluid | 1.3 |
| | Surfactant DC-197 | 2.6 |
| Part B: | Ancamine 2678 | 14.3 |
| | Surfactant DC-197 | 2.6 |

The feed rate of the reaction mixture in the intermediate chamber was 170 ml per min, and the residence time was 3 min. Outlet temperature of the reaction mixture was 63° C.

### Example 2

| Components | | Content (vol. %) |
|---|---|---|
| Part A: | Epoxy resin DER-324 | 53.5 |
| | ASBO | 13.1 |
| | Surfactant DC-197 | 2.6 |
| Part B: | Ancamine 2678 | 17.6 |
| | Surfactant DC-197 | 5.5 |
| | Enovate ® 3000 | 10.3 |

The feed rate of the reaction mixture in the intermediate chamber was 125 ml per min, and the residence time was 4 min. Outlet temperature of the reaction mixture was 49° C.

### Example 3

| Components | | Content (vol. %) |
|---|---|---|
| Part A: | Epoxy resin DER-331 | 66.7 |
| | Surfactant DC-197 | 5.0 |
| | FEA 1100 | 3.3 |
| Part B: | HFC-C* | 17.6 |
| | FEA 1100 | 7.4 |

*hydroxycarbamate functional compound on the basis of Ancamine 2678 and Cycloate A.
The feed rate of the reaction mixture in the intermediate chamber was 100 ml per min, residence time of 5 min. Outlet temperature of the reaction mixture was 49° C.

### Example 4

| Components | | Content (vol. %) |
|---|---|---|
| Part A: | Epoxy resin DER-331 | 66.4 |
| | Surfactant DC-197 | 5.0 |
| | FEA 1100 | 3.6 |
| Part B: | HFC-C* | 14.6 |
| | FEA 1100 | 10.4 |

*hydroxycarbamate functional compound on the base of Jeffamine EDR-148 and CSBO.
The feed rate of the reaction mixture in the intermediate chamber was 70 ml per min, residence time—7 min. Outlet temperature of the reaction mixture was 43° C.

### Example 5

| Components | | Content (vol. %) |
|---|---|---|
| Part A: | Epoxy resin DER-331 | 56.7 |
| | MCure-400 | 10.0 |
| | Surfactant DC-197 | 3.3 |
| Part B: | Ancamine 2678 | 12.8 |
| | Surfactant DC-197 | 5.5 |
| | Enovate ® 3000 | 10.0 |
| | HUM-01 | 5.0 |

In one or more embodiments, the feed rate of the reaction mixture in the intermediate chamber is 500 ml per min, and the residence time was 1 min. Outlet temperature of the reaction mixture was 33° C.

In one or more embodiments, foam formation is achieved by foaming a blowing agent during exothermic curing reactions. The composition is applied onto a vertical concrete substrate and the application process was evaluated by “tack-free time”, which is between the beginning of the foam pour and the point at which the outer skin of the foam loses its stickiness.

The obtained properties of the nonisocyanate polymer foams are summarized in Table 2.

TABLE 2

| | Number of Example | | | | |
|---|---|---|---|---|---|
| Properties | 1 | 2 | 3 | 4 | 5 |
| Viscosity | 2500 | 2500 | 3300 | 3200 | 3500 |
| (Brookfield RVDV II, | | | | | |
| Spindle 29, 20 rpm) | | | | | |
| at 25° C., cP | | | | | |
| Curing time at 25° C.: | | | | | |
| Touch dry, s | 30-40 | 10-15 | 20-25 | 20-25 | 10-15 |
| Curing for transportation, | 50-60 | 20-25 | 30-35 | 30-35 | 20-25 |
| min | | | | | |
| Compressive properties | 0.2 | 0.4 | 0.2 | 0.2 | 0.3 |
| of rigid cellular | | | | | |
| plastics, 24 hours, MPa | | | | | |
| Apparent density of | 25 | 30 | 40 | 37 | 35 |
| cellular plastics, kg/m³ | | | | | |
| Thermal transmission, | 3.0 | 4.5 | 4.9 | 4.2 | 4.7 |
| hr · ft² ° F./Btu · in | | | | | |

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. Thus, compounds mentioned for parts (A) and (B) were given only as examples, and other amino-reactive components, amino-containing components, blowing agents, and additives can be used. The apparatuses for carrying out the method can widely vary provided they are equipped with an intermediate chamber and control of the process optimization parameter.

Moreover, other implementations of the invention will be apparent to those skilled in the art from consideration of the specification and practice of the invention disclosed herein. Various aspects and/or components of the described embodiments may be used singly or in any combination in the systems and methods for spray foaming. It is intended that the specification and examples be considered as exemplary only, with a true scope and spirit of the invention being indicated by the following claims.

What is claimed is:

1. A method for forming a sprayable nonisocyanate foam composition for spray application comprising:
providing a foam spraying apparatus comprising a mixing chamber, at least a first material loading device for dosed input of a part (A) material and a second loading material device for dosed input of a part (B) material to the mixing chamber, an intermediate chamber connected to the mixing chamber, a heater for heating the content of the intermediate chamber, a control unit comprising a temperature sensor for measuring temperature in the intermediate chamber, a differential thermocouple for maintaining the temperature in the intermediate chamber at a constant level, and a discharge nozzle for discharging the product from the intermediate chamber;
supplying dosed quantities of the part (A) material and part (B) material of the nonisocyanate polymer composition to the mixing chamber, the components being mutually reactive;
uniformly mixing the part (A) material and part (B) material and starting a reaction between these materials for forming a foamable nonisocyanate polymer composition;
creating quasiadiabatic conditions in the intermediate chamber, transferring the foamable nonisocyanate polymer composition to the intermediate chamber, and continuously moving the foamable nonisocyanate polymer composition through the intermediate chamber at a predetermined flow rate;
controlling the temperature of the foamable nonisocyanate polymer composition in the intermediate chamber with use of the temperature sensor and the differential thermocouple so as to provide parameters of and conditions for the formation of a foamable nonisocyanate composition most optimal for spray application; and
spraying the foamable nonisocyanate polymer composition from the intermediate chamber through the discharge nozzle onto the substrate.

2. The method of claim 1, wherein the part (A) material comprises at least an amino-reactive compound and the part (B) material comprises at least an amino-containing compound, and wherein either the part (A) material or either the part (B) material, or both, contain at least a blowing agent.

3. The method of claim 2, wherein the parameters of and conditions for the formation of a foamable nonisocyanate composition most optimal for spray application with the use of said foam-spraying apparatus are determined before spray application in a test chamber.

4. The method of claim 3, wherein the composition parameters and conditions for the formation of a foamable nonisocyanate composition most optimal for spray application comprise a predetermined residence time for the foamable nonisocyanate polymer composition in the intermediate chamber and for the flow rate of the composition during its movement through the intermediate chamber.

5. The method of claim 4, wherein the predetermined residence time of the foamable nonisocyanate polymer composition in the intermediate chamber is defined as cream time, which is the interval between mixing together the composition components and the first definite appearance of the foam.

6. The method of producing sprayed nonisocyanate polymer foam according to claim 1, wherein a volume ratio of the part (A) material to the part (B) material ranges from (2:1) to (6:1).

7. The method of claim 2, wherein the amino-reactive compound of the part (A) material is selected from the group consisting of an epoxy functional compound, an acrylic functional compound, a methacrylic functional compound, a cyclic carbonate functional compound, and a mixture thereof; and wherein the amino-containing compound of the part (B) material is selected from the group consisting of a primary amine functional compound, a secondary amine functional compound, a tertiary amine functional compound, a hydroxycarbamate functional compound, and/or a mixture thereof.

8. The method of claim 3, wherein the amino-reactive compound of the part (A) material is selected from the group consisting of an epoxy functional compound, an acrylic functional compound, a methacrylic functional compound, a cyclic carbonate functional compound, and mixtures thereof; and wherein the amino-containing compound of the part (B) material is selected from the group consisting of a primary amine functional compound, a secondary amine functional compound, a tertiary amine functional compound, a hydroxycarbamate functional compounds, and/or a mixture thereof.

9. The method of claim 5, wherein the amino-reactive compound of the part (A) material is selected from the group consisting of an epoxy functional compound, an acrylic functional compound, a methacrylic functional compound, a cyclic carbonate functional compound, and a mixture thereof; and wherein the amino-containing compound of the part (B) material is selected from the group consisting of a primary amine functional compound, a secondary amine functional compound, a tertiary amine functional compound, a hydroxycarbamate functional compound, and/or a mixture thereof.

10. The method of claim 2, where the blowing agent is selected from the group consisting of saturated hydrofluorocarbons, unsaturated hydrofluorocarbons, unsaturated hydrochlorofluorocarbons, hydrocarbons, and alkylhydrogen siloxanes.

11. The method of claim 5, wherein the blowing agent is selected from the group consisting of saturated hydrofluorocarbons, unsaturated hydrofluorocarbons, unsaturated hydrochlorofluorocarbons, hydrocarbons, and alkylhydrogen siloxanes.

12. The method of claim 8, wherein the blowing agent is selected from the group consisting of saturated hydrofluorocarbons, unsaturated hydrofluorocarbons, unsaturated hydrochlorofluorocarbons, hydrocarbons, and alkylhydrogen siloxanes.

13. The method of claim 2, wherein the foamable nonisocyanate polymer composition further comprises a surface-active substance.

14. The method of claim 8, wherein the foamable nonisocyanate polymer composition further comprises a surface-active substance.

15. The method of claim 12, wherein the foamable nonisocyanate polymer composition further comprises a surface-active substance.

16. The method of claim 13, where the blowing agent and the surface-active agent are included in the part (A) material and/or the part (B) material and are dozed into the mixing chamber together with the amino-reactive compound and/or the amino-containing compound.

17. The method of claim 14, where the blowing agent and the surface-active agent are included in the part (A) material and/or the part (B) material and are dozed into the mixing chamber together with the amino-reactive compound and/or the amino-containing compound.

18. The method of claim 15, where the blowing agent and the surface-active agent are included in the part (A) material and/or the part (B) material and are dozed into the mixing chamber together with the amino-reactive compound and/or the amino-containing compound.

19. The method of claim 17, wherein the foamable nonisocyanate polymer composition that exits from the discharge nozzle provides tack-free time according to ASTM D7487, which is no more than 60 seconds for the formation of the foam in a wide range of properties from rigid to flexible.

20. The method of claim 18, wherein the foamable nonisocyanate polymer composition that exits from the discharge nozzle provides tack-free time according to ASTM D7487, which is no more than 60 seconds for the formation of the foam in a wide range of properties from rigid to flexible.

21. A method for forming a sprayable nonisocyanate polymer composition for spraying onto a substrate, the method comprising the following steps:
providing a dosed amount of at least a first component of the sprayable nonisocyanate composition;
providing a dosed amount of at least a second component of the sprayable nonisocyanate composition, said first and second sprayable nonisocyanate compositions reacting with each other when mixed;
mixing said first and second sprayable nonisocyanate compositions in order to start the reaction and to form a sprayable nonisocyanate polymer foam composition;
continuously moving the component mixture under quasiadiabatic conditions toward the substrate at a predetermined flow rate;
controlling the temperature of the sprayable nonisocyanate polymer foam composition to provide parameters of and conditions for the formation of a foamable nonisocyanate composition most optimal for spray application; and
spraying the foamable nonisocyanate polymer foam composition onto the substrate.

22. The method of claim 21, wherein the first component comprises at least an amino-reactive compound and the second component comprises at least an amino-containing compound, and wherein either the first component or the second component, or both, contain at least a blowing agent.

23. The method of claim 22, wherein the parameters of and conditions for the formation of a sprayable nonisocyanate polymer foam composition most optimal for spray application are tested before spray application.

24. The method of claim 23, wherein the composition parameters and conditions for the formation of a sprayable nonisocyanate polymer foam composition most optimal for spray application comprise a predetermined residence time for the sprayble nonisocyanate polymer foam composition in said step of continuously moving the foamable nonisocyanate polymer composition under quasiadiabatic conditions toward the substrate.

25. The method of claim 24, wherein the predetermined residence time of the foamable nonisocyanate polymer composition is defined as cream time, which is the interval between mixing together the composition components and the first definite appearance of the foam.

26. The method of producing sprayed nonisocyanate polymer foam according to claim 21, wherein the volume ratio of the first component to the second component ranges from (2:1) to (6:1).

27. The method of claim 22, wherein the amino-reactive compound of the part (A) material is selected from the group consisting of an epoxy functional compound, an acrylic functional compound, a methacrylic functional compound, a cyclic carbonate functional compound, and a mixture thereof; and wherein the amino-containing compound of the part (B) material is selected from the group consisting of a primary amine functional compound, a secondary amine functional compound, a tertiary amine functional compound, a hydroxycarbamate functional compound, and a mixture thereof.
